(19) United States
(12) Patent Application Publication
(10) Pub. No.: US 2012/0166977 A1
(43) Pub. Date: Jun. 28, 2012

(54) USER PROGRAMMING ACCESS TO DATA MODEL IN USER INTERFACE DESIGN

(76) Inventors: HILMAR DEMANT, Karlsdorf (DE); Sebastian Droll, Heidelberg (DE); Joachim Fitzer, Schriesheim (DE); Ioannis Grammatikakis, Maxdorf (DE); Jan Heiler, Walldorf (DE); Juergen Sattler, Wiesloch (DE); Frank Schertel, Mannheim (DE); Markus Viol, Walldorf (DE); Thorsten Weber, Mannheim (DE)

(21) Appl. No.: 12/978,654

(22) Filed: Dec. 27, 2010

(51) Int. Cl. G06F 3/01

(52) U.S. Cl. 715/762

(57) ABSTRACT

Various embodiments of systems and methods for user programming access to data model in user interface design are described herein. User interface modeling is merged with a scripting language for additional functionalities. In one aspect, scripting enhances the dynamic access to the whole user interface model. In another aspect, additional controller and navigation logic is exposed by means of script inputs. A user can model, bind and run advanced logic through runtime declaration.

### FIELD

The field relates to user interface (UI) technology. More precisely, the field relates to user programming access to data model in UI design.

### BACKGROUND

In the world of computing, Web applications such as Rich Internet Applications (RIAs) have many of the characteristics of desktop applications. The RIAs are typically delivered either by a site-specific browser, a browser plug-in, or independently via a virtual machine. The most commonly used frameworks that support such Web applications are Adobe Flash™, Java™, and Microsoft Silverlight™. Generally, the framework has to be installed using the computer's operating system prior to launching the RIA. The Web application framework typically downloads, updates, verifies, and executes the RIA. Microsoft Silverlight (WPF/E) is a programmable Web browser plug-in that enables features such as animation, vector graphics and audio-video playback that characterize RIAs. Microsoft Silverlight brings additional interactivity features and support for .NET languages and development tools. It is compatible with multiple Web browser products.

Many Web application frameworks follow the Model View Controller (MVC) architectural pattern to separate the data model with the business logic from the user interface. The MVC pattern modularizes code, promotes code reuse (use of existing software code, or software knowledge, to build new software code), and allows multiple interfaces to be applied. The MVC architecture consists of a model, a view, and a controller. The model part of the MVC pattern is a domain-specific representation of the data upon which the application operates. Domain logic adds meaning to raw data (for example, calculating the totals, taxes, and shipping charges for shopping cart items). When a model changes its state, it notifies its associated views so they can refresh. The view of the MVC pattern renders the model into a form suitable for interaction, typically a user interface element. Multiple views can exist for a single model for different purposes. The controller of the MVC pattern receives input and initiates a response by making calls on model objects. When a Web application user interface framework is built on the MVC architectural pattern approach, high speed development of uniform user interfaces (UIs) is possible.

### SUMMARY

Various embodiments of systems and methods for user programming access to data model in user interface design are described herein. In one embodiment, the method includes receiving a selection of one or more user interface (UI) components to form a UI model and binding at least one component from the one or more UI components to a data structure in a backend system. The method also includes receiving a user action for UI design at runtime, the user action accessing the data structure in the backend system for UI customization and rendering the UI model as a UI view.

In other embodiments, the system includes at least one processor for executing program code and memory, a display to render a UI, an input device to receive one or more script inputs to customize the UI, and a repository within the memory to persist a UI data model and backend data. The system also includes a scripting engine within the memory to interpret the one or more script inputs.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating an architectural view of a user interface framework as part of an application platform.

FIG. 2 is a block diagram illustrating an additional controller in the MVC architecture for defining UIs, according to an embodiment.

FIG. 3 is a flow diagram of an embodiment of a method for user programming access to data model in user interface design.

FIG. 4 is a block diagram of an embodiment of a system for user programming access to data model in user interface design.

FIG. 5 is a block diagram illustrating a computing environment in which the techniques described for user programming access to data model in user interface design can be implemented, according to an embodiment of the invention.

### DETAILED DESCRIPTION

Embodiments of techniques for user programming access to data model in user interface design are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

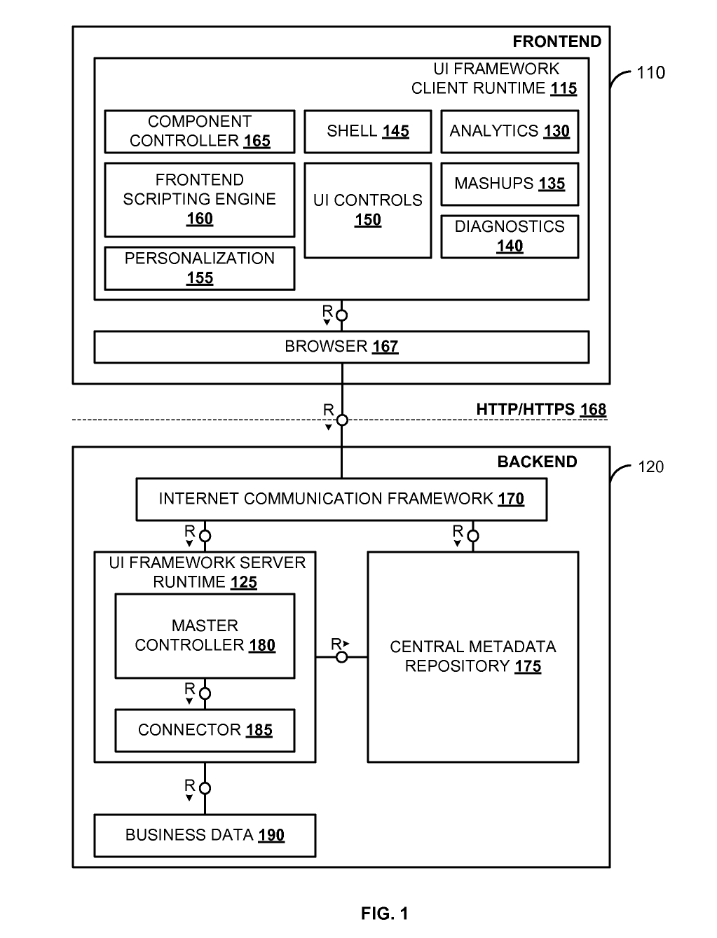

FIG. 1 is a block diagram illustrating an architectural view of a user interface framework as part of an application platform. The application platform is a Web application server including a frontend (client) part 110 and a backend (server) part 120. The UI framework as part of the application platform is responsible for generating, rendering, and managing user interfaces. The UI framework enables the full separation of UI entities in multiple clients, provides a rendering-engine-independent definition of application UIs and has all the personalization and flexibility features built-in. The UI framework is based on the RIA concept, which removes the need of running Java server in the middle tier for application UI purposes. In this way, the complexity of the UIs is reduced significantly. The UI framework includes a client part—UI Framework Client Runtime 115, and a server part—UI Framework Server Runtime 125.

UI Framework Client Runtime 115 may be implemented in a programming language such as “C#” using a RIA based framework such as Microsoft Silverlight technology. The UI Framework Client Runtime 115 is responsible for rendering user interfaces and access business data from backend 120. Every user request is triggered on the UI Framework Client Runtime 115. The very first request is a navigation request that results in a request to the backend 120 to read a UI component. The UI component is read from the Central Metadata Repository 175 in the backend 120 and transported to the frontend 110. A component manager instantiates the UI component and a corresponding component controller 165 for the UI component on the frontend 110 and triggers the initialization of the UI component on the backend 120. The component manager builds up a control tree for the UI component out of a set of UI controls 150. These UI controls 150 ensure conformable look and feel and the ability to change UI themes consistently. The controls in the “themed UI controls” package are all enabled in a consistent way for test automation and accessibility, and are provided in a manner that all native implemented custom UI panes can take use of that controls. Usually, more than one UI component is needed to render a UI, as UI components typically embed other UI components (e.g., a Work Center component embeds a set of Work Center View Components and they again embed other components). The top-level UI component that is rendered is the root UI component which makes sure to render a common frame for all UI components, e.g., by rendering the top level navigation and the ability for personalization from personalization 155 unit.

In an embodiment, the UI Framework Client Runtime 115 also comprises the following built-in units: analytics 130, mashups 135, diagnostics 140, shell 145, and frontend scripting 160. Analytics 130 are components that represent data in a grouped, aggregated, and hierarchical way. These components serve to answer business questions about, for example, how many products were sold in a particular country and provide drill down capabilities to different level of abstraction. Diagnostics 140 allows the collection of, for example, the context of the current framework and all other running entities of the overall system at a specific point in time (e.g., in case of an exception or error). The collected information can help to track down the cause of the exception. Shell unit 145 provides the shell for running the UI Framework Client Runtime. It includes all units for the user interface ranging from defining the overall appearance of windows (including standard elements like menus, toolbars, navigation areas, windows management) as well as the mediator layer that maps logical component definitions from the configuration model to physical controls. Shell unit 145 represents a standalone native client (WPF) based on the Silverlight technology. Frontend scripting 160 enables data from the client side data model to be read, evaluated, and modified—which eventually causes configured events again in the runtime execution of the model. With these capabilities, UI-only logic can be expressed and modeled via some script; it is not required to implement or model the logic in the backend. Optionally, the script can be executed on the client or backend.

The frontend 110 communicates with the backend 120 via browser 167 on a regular HTTP/HTTPs connection 168 using JavaScript Object Notation (JSON) (also other serialization formats such as XML can be used in parallel to JSON) as a lightweight data interchange format. The requests from the frontend 110 are received at Internet Communication Framework (ICF) 170. The ICF 170 forwards the requests to the UI Framework Server Runtime 125 and Central Metadata Repository 175. The Central Metadata Repository 175 stores all UI entities with their metadata. The UI Framework Server Runtime 125 reads and interprets the UI model of the application, manages the access to the backend and ensures an optimized communication with the UI Framework Client Runtime 115. After the UI Framework Client Runtime 115 triggers the initialization of a UI component in the backend 120 for a first time in a session, the UI Framework Server Runtime 125 first creates a master controller 180 for the complete session and then creates a component controller for each component that is requested from the UI Framework Client Runtime 115. Each component controller builds a UI data container out of the information of the UI model for a component. At runtime, the composition of the dependent components is combined within the master controller 180, which holds one event queue and performs data updates for all included components as one component. In an embodiment, it can be configured that logically separated declared components to run as one virtual controller at runtime.

After the master controller 180 has processed all component controllers, it collects all the data that has changed in the UI data container and makes sure that all changed data and only the changed data is transported to the client 110. The access from the UI Framework Server Runtime 125 to business data 190 is performed via connector 185. Connector 185 is able to connect to different technologies.

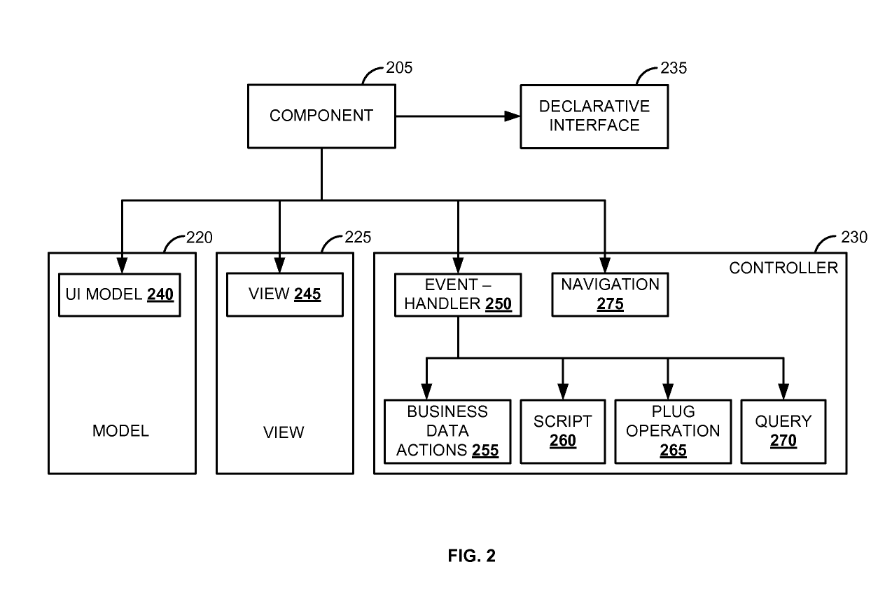

FIG. 2 is a block diagram illustrating a logical component structure. Component 205 is a self-contained model of a user interface that can be declaratively used in another UI model. Component 205 consists mainly of a model 220, a View 225, a Controller 230, and a declarative interface 235. View 225 consists of a set of views, such as view 245, which is the description of the user interface that binds to the UI model 240 and triggers event-handlers such as event-handler 250. The UI model 240 describes a data structure, which can bind to backend business data 190. Controller 230 includes different types of event-handlers such as: business data actions 255, script 260, plug operations 265, and query 270. Business data actions 255 include several types of actions defined in the metadata and exposed through the implementation of the business objects. From the UI, an operation of type “BOAction” could be used to trigger a particular action in the context of the current data instance, which again potentially can change the state and data as well. Script 260 is a declaring script logic on the data instances (e.g., read, evaluate, modify) with branches, conditions, etc. A plug operation, from plug operations 265, triggers one of the defined out-ports which are used to couple components (embedded or navigation) together. Query 270 in combination with a filter set called “DefaultSets” can be executed from an event handler operation. The defined query of the business object is executed and the query result data is filled into the configured data model list. Navigation 275 is the context mapping for outgoing-incoming operations. The declarative interface 235 exposes ports (in-port and out-port), binding-capabilities for tightly coupled behavior in embedded scenarios, and configuration to the composition environment.

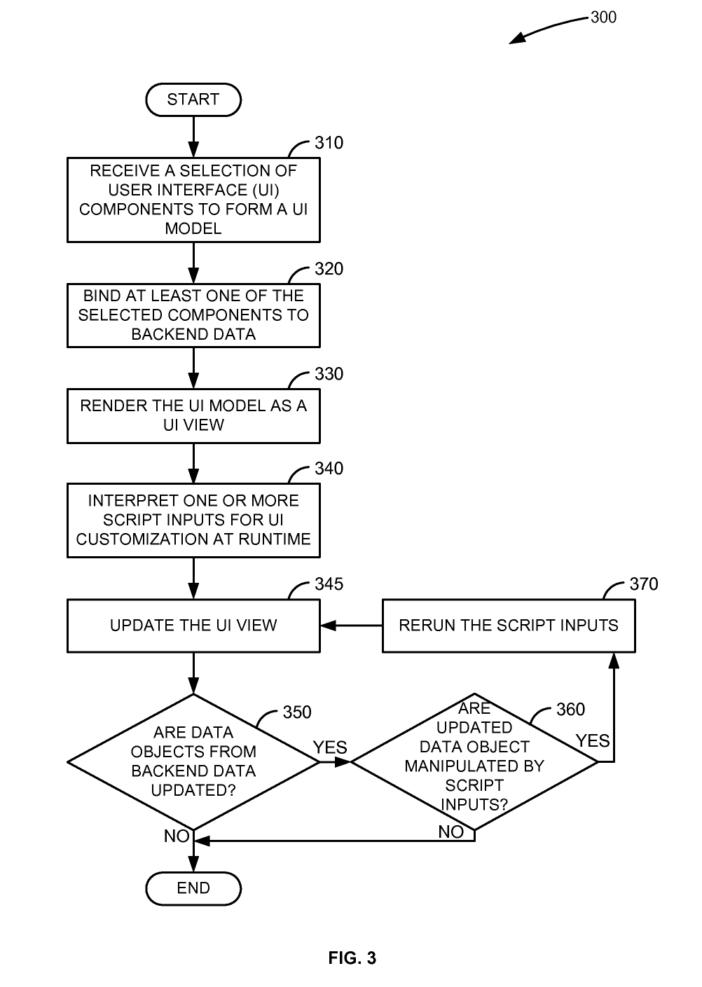

FIG. 3 is a flow diagram of an embodiment of a method 300 for user programming access to data model in user interface design. The method begins at block 310 with receiving a selection of user interface (UI) components to form a UI model. For example, the user selects a floorplan, pane containers within the floorplan, fields, buttons, etc. This user selection forms a data model structure. In one embodiment, the data model structure is persisted in an extensible markup language (XML) file. Then, at block 320, the selected components of the UI are bound to backend data. For example, a field of the UI is bound to a data field of the backend data. In one embodiment, in case of business environment, a component may be bound to metadata of a business object (BO). Thus, BO metadata is directly introduced into the UI model. Not all components need to be bound to backend data. Some fields may have just informative function and they are not referred to any backend data. It depends on the business logic of the UI being modeled. In one embodiment, none of the UI components are bound to backend data. At block 330, the UI model is rendered as UI view. The view represents the declared model with all its connections to the backend data.

At block 340, script inputs for UI customization are interpreted at runtime. The function of the script inputs is to introduce controller and navigation logic to the UI model. In one embodiment, the scripts access and manipulate data objects from the backend data. Typically, the script inputs are predefined and thus there is a set of operations allowed to be performed by the script inputs. For example, in one embodiment, an instance of the script inputs may be used for calling an event handler. In another embodiment, script inputs define a calculation rule for a component of the UI model. In yet another embodiment, script inputs may be used for invalidating a control in the UI.

At block 345, the UI view is updated. The UI view is updated based on the interpreted script inputs for UI customization. The script inputs change the UI model and hence the UI view.

At decision block 350, a check is performed on whether data objects of the backend data are updated. If there is no change in the backend data, the UI view remains intact. If some of the data in the backend changes, a new check is performed at decision block 360, whether the updated data objects are processed by script inputs. In case the updated data is not affected by script inputs, the UI remains intact, otherwise, the method continues at block 370 with rerunning the script inputs and updating the UI view at block 345. This is necessary in order for the applied controller and navigation logic to be updated according to the latest updates of the backend data.

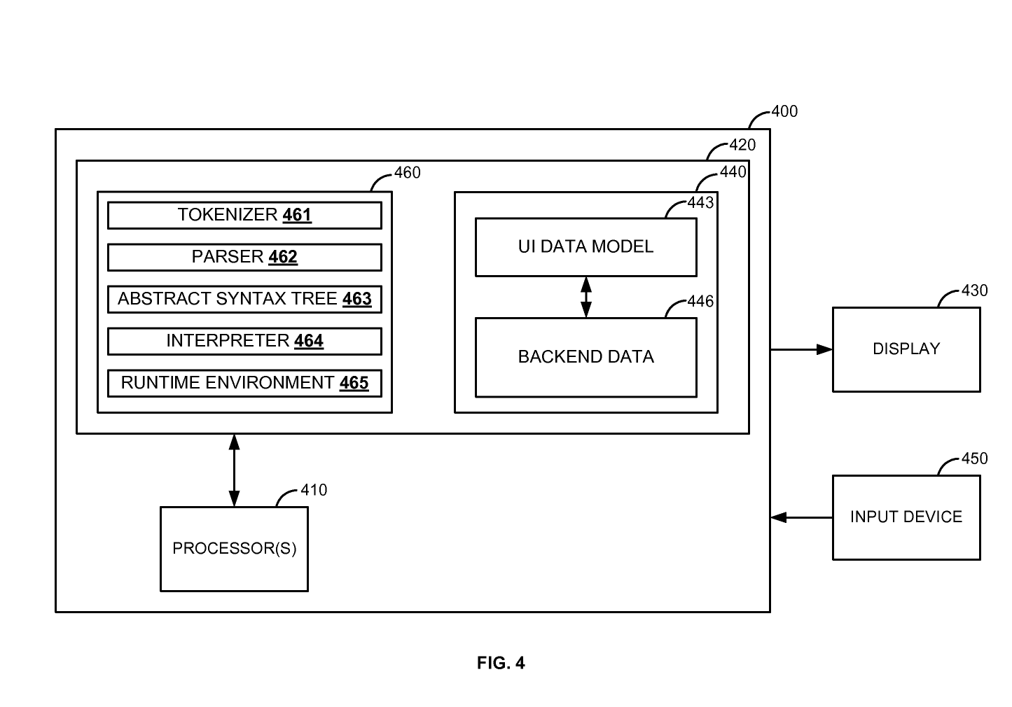

FIG. 4 is a block diagram of an embodiment of a system 400 for user programming access to data model in user interface design. The system includes one or more processors 410 for executing program code. Computer memory 420 is in connection to the one or more processors 410. The system 400 is connected to a display 430 for visualization of UIs and to an input device 450 to receive user's script inputs for UI customization.

The system 400 further includes a repository 440 within the memory 420, the repository 440 to persist a UI data model 443 for UI generation and backend data 446. The memory 420 also includes a scripting engine 460 to process the one or more script inputs received through the input device 450. In one embodiment, the UI data model 443 is persisted in an XML file. In another embodiment, components of the UI data model 443 are bound to data objects of the backend data 446. In yet another embodiment, the data objects of the backend data 446 are business object metadata.

In one embodiment, the scripting engine 460 includes a tokenizer 461, a parser 462, an abstract syntax tree 463, an interpreter 464, and runtime environment 465. The tokenizer 461 is based on lexical definition to split the script inputs in tokens. The parser 462 is based on grammar to parse the script inputs and analyze syntax. The abstract syntax tree 463 is formed by outputs from the tokenizer 461 and the parser 462. The interpreter 464 is intended to interpret the abstract syntax tree. The runtime environment 465 provides access to the UI data model 443. In one embodiment, the runtime environment 465 consists of a script context module (not shown) where UI data model objects are declared and a data wrapper interface (not shown) to define accessible data values.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

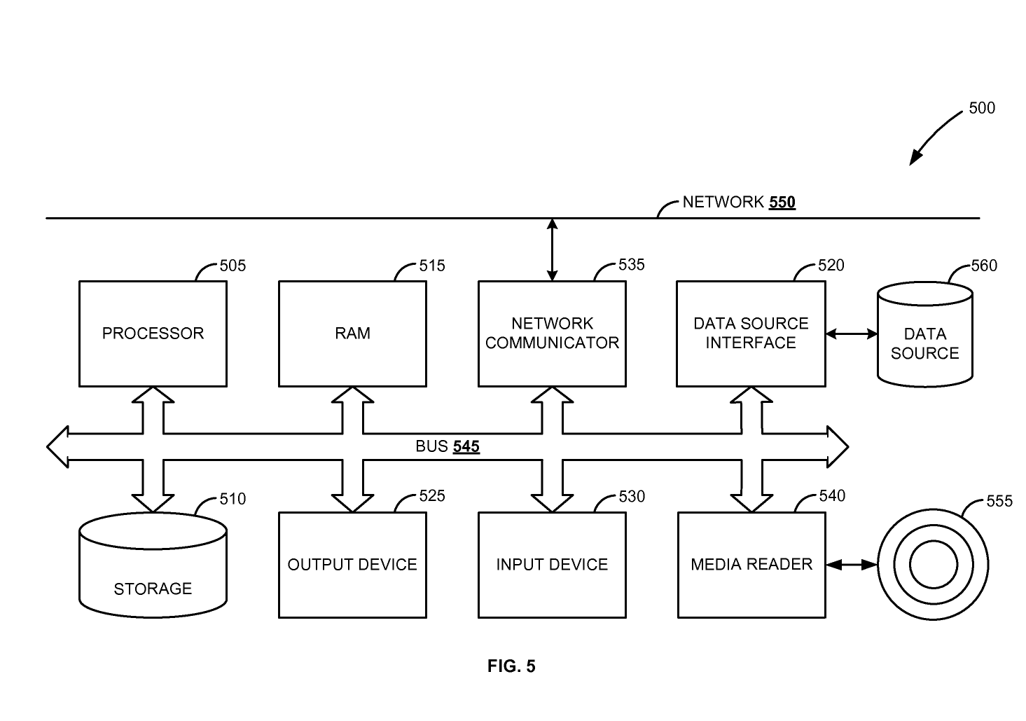

FIG. 5 is a block diagram of an exemplary computer system 500. The computer system 500 includes a processor 505 that executes software instructions or code stored on a computer readable storage medium 555 to perform the above-illustrated methods of the invention. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment of the invention, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a non-transitory computer readable storage medium to tangibly store instructions, which when executed by a computer, cause the computer to:
receive a selection of one or more user interface (UI) components to form a UI model;
bind at least one component of the one or more UI components to backend data;
render the UI model as UI view;
interpret one or more script inputs for UI customization at runtime; and
update the UI view based on the UI customization.

2. The article of manufacture of claim 1, wherein the UI model is saved as a data model structure in an extensible markup language (XML) file.

3. The article of manufacture of claim 1, wherein the instructions to bind the at least component to the backend data further cause the computer to bind the at least one component of the one or more UI components to metadata of a business object (BO).

4. The article of manufacture of claim 1, wherein the one or more script inputs are predefined.

5. The article of manufacture of claim 1, wherein the instructions to interpret one or more script inputs for UI customization further cause the computer to access and manipulate data objects of the backend data.

6. The article of manufacture of claim 1, wherein the instructions to interpret one or more script inputs for UI customization further cause the computer to execute controller and navigation logic on the UI model.

7. The article of manufacture of claim 5, further comprising instructions to rerun the script inputs and update the UI view when the accessed and manipulated data objects of the backend data are updated.

8. A computerized method for UI modeling, the computer including at least one processor for executing program code and memory, the method comprising:
receiving a selection of one or more user interface (UI) components to form a UI model;
binding at least one component from the one or more UI components to a data structure in a backend system;
receiving a user action for UI design at runtime, the user action accessing the data structure in the backend system for UI customization; and
rendering the UI model as a UI view.

9. The method of claim 8, wherein receiving a user action for UI design at runtime further comprises interpreting one or more script inputs for the UI customization.

10. The method of claim 9, wherein the one or more script inputs are predefined.

11. The method of claim 10, wherein the one or more script inputs access data objects of the data structure in the backend system.

12. The method of claim 10, wherein a first instance of the one or more script inputs calls an event handler.

13. The method of claim 10, wherein a second instance of the one or more script inputs defines a calculation rule for a component from the one or more UI components.

14. The method of claim 10, wherein a third instance of the one or more script inputs invalidates a control in the UI model.

15. A computer system for UI modeling including at least one processor for executing program code and memory, the system comprising:
a display to render a UI;
a repository within the memory to persist a UI data model and backend data;
an input device to receive one or more script inputs to customize the UI; and
a scripting engine within the memory to interpret the one or more script inputs.

16. The system of claim 15, wherein the UI data model is persisted in an XML file.

17. The system of claim 15, wherein components of the UI data model are bound to data objects of the backend data.

18. The system of claim 17, wherein the data objects are business object metadata.

19. The system of claim 15, wherein the scripting engine further comprises:
a tokenizer based on a lexical definition to split the script inputs in tokens;
a parser based on a grammar to parse the script inputs and analyze syntax;
an abstract syntax tree formed by outputs from the tokenizer and the parser;
an interpreter to interpret the abstract syntax tree; and
runtime environment to provide access to the UI data model.

20. The system of claim 19, wherein the runtime environment further comprises:
a script context module, where UI data model objects are declared; and
a data wrapper interface to define accessible data values.
